(19) United States
(12) Patent Application Publication
(10) Pub. No.: US 2024/0150871 A1
(43) Pub. Date: May 9, 2024

(54) Al-Mg series aluminum alloy sheet, a preparation method and use thereof

(71) Applicant: Chinalco Materials Application Research Institution Co., Ltd., Beijing (CN)

(72) Inventors: Xiaodong MAO, Beijing (CN); Yingdong LI, Beijing (CN); Pizhi ZHAO, Beijing (CN); Jingwei ZHAO, Beijing (CN); Guoqiang HU, Beijing (CN); Zhenshan LIU, Beijing (CN); Ningjie GU, Beijing (CN); Guojun WANG, Beijing (CN); Xiaoyu SONG, Beijing (CN)

(21) Appl. No.: 18/374,009

(22) Filed: Sep. 28, 2023

(30) Foreign Application Priority Data
Nov. 9, 2022 (CN) 202211395649.9

(51) Int. Cl. C22C 21/08; C21D 8/02; C21D 9/46; C22C 1/02; C22F 1/047; C23C 22/07; C23G 1/14

(52) U.S. Cl. CPC C22C 21/08; C21D 8/0226; C21D 8/0236; C21D 8/0263; C21D 8/0268; C21D 8/0273; C21D 9/46; C22C 1/026; C22F 1/047; C23C 22/07; C23G 1/14

(57) ABSTRACT

The disclosure relates an Al—Mg series aluminum alloy sheet, a preparation method and use thereof. The preparation method includes: step S1, melting and casting the alloy raw materials in sequence to obtain an aluminum alloy ingot; step S2, subjecting the aluminum alloy ingot to a two-stage homogenization treatment so as to obtain a homogenized aluminum alloy ingot; and step S3, subjecting the homogenized aluminum alloy ingot to hot rolling, primary cold rolling, intermediate annealing, final cold rolling, and finished product annealing in sequence to obtain the aluminum alloy sheet.

### CROSS-REFERENCE TO RELATED APPLICATION

This application is based on Chinese Patent Application No. 202211395649.9, filed Nov. 9, 2022, which claims the benefit of priority to the Chinese Patent Application, which is incorporated by reference in its entirety herein.

### TECHNICAL FIELD

The present disclosure relates to the field of aluminum alloy material processing, in particular to an Al—Mg series aluminum alloy sheet, a preparation method and use thereof.

### BACKGROUND

The development of the automotive industries have brought enormous pressures on energy and the environment. Under the premise of ensuring the strength and safety performance of automobiles, minimizing the overall weight of automobiles can effectively reduce fuel consumption and exhaust pollution. Aluminum alloy has become the most ideal material for the lightweight of automobiles due to its high strength, stiffness, good processing formability, and high recycling rate.

Al—Mg aluminum alloy is an important material for body structural member and cover panel inner plate, which is required to have both good mechanical properties and good resistance to intergranular corrosion and phosphating properties. Phosphating is an important pre-treatment process of an aluminum alloy material before electrophoresis and paint spraying and coating. Through the phosphating treatment, a dense phosphating film can be formed on the surface of aluminum alloy. On the one hand, it can increase the contact area with the paint film and improve the bonding ability of the paint film; and on the other hand, it can improve the corrosion resistance of the base aluminum material.

In recent years, a large amount of researches has been conducted on the phosphating treatment process of an aluminum alloy automobile sheet. Both CN107245708A and CN105543833A propose a surface phosphating treatment process or method for an aluminum alloy material, but both of which are from the point of view of phosphating processes and do not combine the preparation processes of an aluminum alloy sheet. CN 113322455A provides a phosphating reagent for black phosphating of a surface of aluminum-silicon alloy and a phosphating method, proposes an aluminum phosphating solution that does not contain heavy metal ions, and optimizes the corresponding phosphating process, eliminating surface conditioning and achieving a phosphating effect of black appearance. However, this invention is only applicable to an aluminum-silicon alloy. CN 108103367A proposes an aluminum alloy sheet and its preparation method for automobile bodies, which also has certain phosphating properties, but it mainly targets at 6xxx aluminum alloy sheets.

The above solutions mainly focus on the phosphating treatment processes, which is helpful for the corrosion resistance of an aluminum alloy sheet to a certain extent, but there is still great room for improvement to meet the safety and stability requirements for automobile sheets.

### SUMMARY

The main object of the present disclosure is to provide an Al—Mg series aluminum alloy sheet, a preparation method and use thereof, so as to solve the problems of insufficient phosphating properties and resistance to intergranular corrosion of an aluminum alloy sheet for automobiles in existing art.

In order to achieve the above object, according to an aspect of the present disclosure, a preparation method of an Al—Mg series aluminum alloy sheet is provided, and the preparation method includes: step S1, melting and casting the alloy raw materials in sequence to obtain an aluminum alloy ingot; wherein the alloy raw materials include the following components as calculated by mass percentage: 0.4% content of Si; ≤0.4% content of Fe; 0.2%-0.5% content of Mn; 2.2%-6.0% content of Mg; 0.3% content of Cr; 0.05%-0.5% content of Cu, and a balance of Al and impurities, with a total amount of impurities being less than 0.15 wt %, and each impurity element content being less than 0.05 wt %; step S2, subjecting the aluminum alloy ingot to a two-stage homogenization treatment so as to obtain a homogenized aluminum alloy ingot; and step S3, subjecting the homogenized aluminum alloy ingot to hot rolling, primary cold rolling, intermediate annealing, final cold rolling, and finished product annealing in sequence to obtain the aluminum alloy sheet.

Further, the two-stage homogenization treatment includes a first-stage homogenization treatment and a second-stage homogenization treatment, wherein the temperature of the first-stage homogenization treatment is 380-460° C., and the temperature of the second-stage homogenization treatment is 490-530° C.

Further, the heat preservation time of the first-stage homogenization treatment is 2-8 hours, and the heat preservation time of the second-stage homogenization treatment is 2-8 hours.

Further, the hot-rolled plate obtained after the hot rolling in step S3 has a thickness of 5.0-8.0 mm.

Further, the sheet obtained from the primary cold rolling in step S3 has a thickness of 1.6-5.0 mm.

Further, in the step S3, the intermediate annealing includes: heating the sheet to 300-350° C. at a heating rate of 20-50° C./h and holding at that temperature for more than 2 hours.

Further, the sheet obtained from the final cold rolling in step S3 has a thickness of 0.8-3.0 mm.

Further, in step S3, the finished product annealing contains: heating the sheet to 450-530° C. at a heating rate of greater than 20° C./s and holding at that temperature for 15s-5 min for continuous annealing, and then cooling same at a rate of greater than 10° C./s.

Further, the step S3 further includes straightening the finished product after annealing, with a straightening amount of 0.5-1%.

Further, the preparation method further includes step S4, subjecting the aluminum alloy sheet to phosphating treatment, wherein the phosphating treatment includes degreasing, water washing, surface conditioning, phosphating, and final water washing in sequence.

Further, the degreasing includes treating with a mixed solution of 3%-5% by mass percentage of an alkaline degreaser and 0.6%-1% by mass percentage of a surfactant at 45-55° C. for 1-10 min;
and/or, the water washing and final water washing includes washing with water for 1-5 min at a washing temperature of 20-30° C.;
and/or, the surface conditioning includes treating with 0.1%-0.2% by mass percentage of a titanium polyphosphate surface conditioning agent for 0.5-5 min at a treating temperature of 20-35° C.;
and/or, the phosphating includes treating with a mixed solution composed of 4%-5% by mass percentage of a main film forming agent, 2%-3% by mass percentage of a neutralizer, 0.1%-0.2% by mass percentage of an accelerator, 0.1%-0.5% by mass percentage of a manganese additive, 0.1%-0.5% by mass percentage of a nickel additive, 0.5%-1% by mass percentage of a fluorosilicate additive and 0.1%-0.5% by mass percentage of a fluoride ion additive for 3-5 min at a treating temperature of 40-60° C., wherein the free acid point of the mixed solution is 1.5-2.0, the total acid point is 25-30, the fluoride ion concentration is 150-200 ppm, and the accelerator gas point is 2-4.

According to another aspect of the present disclosure, an Al—Mg series aluminum alloy sheet is provided, which is prepared by any of the above preparation methods.

According to another aspect of the present disclosure, a use of the Al—Mg series aluminum alloy sheet as described above in the body structural member and/or cover panel inner plate is provided.

By applying the technical solution of the present disclosure, through optimizing the content of each component, especially the microelement Cu, in the Al—Mg series aluminum alloy sheet, as well as the homogenization annealing process, the phosphating reactivity of the material is improved, and the dense and uniform growth of the surface phosphating film is promoted. At the same time, it provides good resistance to intergranular corrosion, ensuring that the alloy's intergranular corrosion performance meets the certification requirements of the main engine plants.

### BRIEF DESCRIPTION OF THE DRAWINGS

The accompanying drawings of the description, which form a part of the application, are used to provide a further understanding of the disclosure. The illustrative examples and their descriptions of the disclosure are used to explain the disclosure, and do not constitute an improper limitation thereto. In the accompanying drawings:

FIG. 1 shows the macroscopic morphology of the Al—Mg series aluminum alloy sheet prepared in example 1 and comparative example 1 of the present disclosure after water boiling test;

FIG. 2 shows the polarization curve test results of the Al—Mg series aluminum alloy sheet prepared in example 1 and comparative example 1 of the present disclosure;

FIG. 3 shows the SEM scanning photographs of the phosphating film of Al—Mg series aluminum alloy sheet prepared in example 1 and comparative example 1 of the present disclosure; and

FIG. 4 shows the metallographic structure of the Al—Mg series aluminum alloy sheet prepared in example 4 and comparative example 3 of the present disclosure after sensitization at 195° C. for 45 min.

### DETAILED DESCRIPTION OF THE EMBODIMENTS

It should be noted that the examples and features in the examples in the application can be combined with each other without conflict. The disclosure will be described in detail below with reference to the drawings and in combination with embodiments.

As analyzed in the background technology, there are problems of insufficient phosphating properties and resistance to intergranular corrosion of an aluminum alloy sheet for automobiles in the prior art. In order to solve such problems, the application provides an Al—Mg series aluminum alloy sheet, a preparation method and use thereof.

According to a typical embodiment of the application, a preparation method of an Al—Mg series aluminum alloy sheet is provided, and the preparation method includes: step S1, melting and casting the alloy raw materials in sequence to obtain an aluminum alloy ingot; wherein the alloy raw materials include the following components as calculated by mass percentage: ≤0.4% content of Si; ≤0.4% content of Fe; 0.2%-0.5% content of Mn; 2.2%-6.0% content of Mg; ≤0.3% content of Cr; 0.05%-0.5% content of Cu, and a balance of Al and impurities, with a total amount of impurities being less than 0.15 wt %, and each impurity element content being less than 0.05 wt %; step S2, subjecting the aluminum alloy ingot to a two-stage homogenization treatment so as to obtain a homogenized aluminum alloy ingot; and step S3, subjecting the homogenized aluminum alloy ingot to hot rolling, primary cold rolling, intermediate annealing, final cold rolling, and finished product annealing in sequence to obtain the aluminum alloy sheet.

Through optimizing the content of each component, especially the microelement Cu, as well as the homogenization annealing process in the preparation method of an Al—Mg series aluminum alloy sheet provided in the application, the phosphating reactivity of the material is improved, and the dense and uniform growth of the surface phosphating film is promoted, at the same time it provides good resistance to intergranular corrosion, ensuring that the alloy's intergranular corrosion performance meets the certification requirements of the main engine plants.

Exemplarily, in terms of mass percentage, the content of Si in the alloy raw materials can be listed as 0%, 0.05%, 0.10%, 0.15%, 0.20%, 0.25%, 0.30%, 0.35%, 0.40%, or a range between any two of above.

Exemplarily, in terms of mass percentage, the content of Fe in the alloy raw materials can be listed as 0%, 0.05%, 0.10%, 0.15%, 0.20%, 0.25%, 0.30%, 0.35%, 0.40%, or a range between any two of above.

Exemplarily, in terms of mass percentage, the content of Mn in the alloy raw materials can be listed as 0.20%, 0.25%, 0.30%, 0.35%, 0.40%, 0.45%, 0.50%, or a range between any two of above.

Exemplarily, in terms of mass percentage, the content of Mg in the alloy raw materials can be listed as 2.2%, 2.5%, 3.0%, 3.5%, 4.0%, 4.5%, 5.0%, 5.5%, 6.0%, or a range between any two of above.

Exemplarily, in terms of mass percentage, the content of Cr in the alloy raw materials can be listed as 0%, 0.05%, 0.10%, 0.15%, 0.20%, 0.25%, 0.30%, or a range between any two of above.

Exemplarily, in terms of mass percentage, the content of Cu in the alloy raw materials can be listed as 0.05%, 0.10%, 0.15%, 0.20%, 0.25%, 0.30%, 0.35%, 0.40%, 0.45%, 0.50%, or a range between any two of above.

The two-stage homogenization treatment is beneficial for improving the uneven crystalline structure formed during the casting process and improving the performance of the aluminum alloy sheets after rolling. The specific operation method can make reference to the existing technology and in this application, the two-stage homogenization treatment has significantly improved the phosphating properties of the prepared Al—Mg series aluminum alloy sheets. In some typical embodiments of the application, the two-stage homogenization treatment includes a first-stage homogenization treatment and a second-stage homogenization treatment, wherein the temperature of the first-stage homogenization treatment is 380-460° C., and the temperature of the second-stage homogenization treatment is 490-530° C. At such treatment temperatures, the improvement of homogenization treatment effect is particularly significant. Preferably, the heat preservation time of the first-stage homogenization treatment is 2-8 hours, and the heat preservation time of the second-stage homogenization treatment is 2-8 hours.

In the above step S3, the homogenized aluminum alloy ingot is subjected to hot rolling, primary cold rolling, intermediate annealing, final cold rolling, and finished product annealing sequentially to obtain the aluminum alloy sheet. Those skilled in the art can easily determine the implementation methods and parameter indicators for each step based on the existing technology. Taking hot rolling as an example, one pass or multiple passes may be used. Preferably, thickness of the hot rolled sheet obtained after hot rolling is 5.0-8.0 mm. primary cold rolling is carried out after hot rolling, and preferably, the thickness of the sheet obtained after primary cold rolling is 1.6-5.0 mm. The cold rolled sheet is subjected to intermediate annealing before final cold rolling. In some embodiments, the thickness of the final cold rolled sheet is 0.8-3.0 mm. After the final cold rolling, the finished product annealing is required to improve the plasticity and toughness of the aluminum alloy sheet.

In some typical embodiments, in the above step S3, the intermediate annealing includes: heating the sheet to 300-350° C. at a rate of 20-50° C./h and holding at that temperature for more than 2 hours. The intermediate annealing temperature is relatively low, and mainly functions to eliminate work hardening, so as to facilitate the smooth running of the subsequent cold processing. The finished product annealing includes: heating the sheet to 450-530° C. at a heating rate of greater than 20° C./s and holding at that temperature for 15s-5 min for continuous annealing, and then cooling same at a rate of greater than 10° C./s, which is beneficial for forming suitable textures. The finished product annealing temperature is relatively high, mainly functions to achieve complete recrystallization of the sheet and adjust the grain structure and the second phase redissolution and precipitation behavior, further improving the material's phosphating reactivity and resistance to intergranular corrosion.

In some embodiments, the step S3 further includes straightening the finished product after annealing, with a straightening amount of 0.5%-1%, so as to facilitate the subsequent phosphating treatment and use.

In some embodiments, the preparation method of the Al—Mg series aluminum alloy sheet of the application also includes a phosphating treatment step, i.e. step S4, which involves subjecting the aluminum alloy sheet to phosphating treatment, wherein the phosphating treatment includes degreasing, water washing, surface conditioning, phosphating, and final water washing in sequence. The above phosphating method can make the surface of the aluminum alloy sheet prepared by the preparation method of the Al—Mg series alloy sheet of the application more completely covered with the phosphating film, thereby having higher coverage and more suitable phosphating crystal size, and having uniform crystal distribution without coarseness.

For the degreasing process in the above phosphating treatment, a mixed solution of 3%-5% by mass percentage of an alkaline degreaser and 0.6%-1% by mass percentage of a surfactant is preferably used for treating at 45-55° C. for 1-10 min, and treated at 45-55° C. for 1-10 min; the water washing and final water washing involve washing with water for 1-5 min at a washing temperature of 20-30° C.; and the above surface conditioning preferably involves treating with 0.1%-0.2% by mass percentage of a titanium polyphosphate surface conditioning agent for 0.5-5 min at a treating temperature of 20-35° C.

In some preferred embodiments, a mixed solution composed of 4%-5% by mass percentage of a main film forming agent, 2%-3% by mass percentage of a neutralizer, 0.1%-0.2% by mass percentage of an accelerator, 0.1%-0.5% by mass percentage of a manganese additive, 0.1%-0.5% by mass percentage of a nickel additive, 0.5%-1% by mass percentage of a fluorosilicate and 0.1%-0.5% by mass percentage of a fluoride ion additive is used for phosphating treatment of the aluminum alloy sheet for 3-5 min at a treating temperature of 40-60° C., preferably, the free acid point of the above mixed solution is 1.5-2.0, the total acid point is 25-30, the fluoride ion concentration is 150-200 ppm, and the accelerator gas point is 2-4.

According to another typical embodiment of the application, an Al—Mg series aluminum alloy sheet is provided, which is prepared by any of the above preparation methods. The aluminum alloy sheet has excellent phosphating properties and good resistance to intergranular corrosion by combining material components and preparation processes.

According to yet another typical embodiment of the application, a use of the Al—Mg series aluminum alloy sheet as described above in the body structural member and/or cover panel inner plate is provided, which not only utilizes the high strength, stiffness, good processing formability of the aluminum alloy sheet, but also has good resistance to intergranular corrosion and phosphating properties.

The beneficial effects that can be realized in the application will be further explained below in combination with the examples and the comparative examples.

### Example 1

Al—Mg alloy included by mass percentage of 0.25% of Si, 0.4% of Fe, 0.3% of Mn, 4.5% of Mg, 0.1% of Cr, 0.14% of Cu and a balance of Al. It was smelted according to the above ratio of alloy components, the melt was cast into an ingot by use of a semi-continuous casting equipment after the refining treatment; the ingot was subjected to homogenization treatment after cropping and milling, with the homogenization process being at 450° C. and heat preservation for 3 hours, followed by 530° C. and heat preservation for 3 hours; afterwards, it was hot rolled to a thickness of 5 mm; the hot rolled plate was cold rolled to 4 mm, and subjected to intermediate annealing, which was heated at a rate of 30° C./h to 350° C. and held at that temperature for 2 hours, and air cooled to room temperature after being discharged from the furnace; then, the subsequent cold rolling was carried out to obtain a 2 mm-thick cold-rolled plate, afterwards the finished product annealing treatment was carried out and heated at a rate of 30° C./s on the continuous annealing line to 530° C. and held at that temperature for 30 seconds before water quenching and then cooled at a rate of 20° C./s. Finally, it was straightened on a straightening machine, with a straightening amount of 1%.

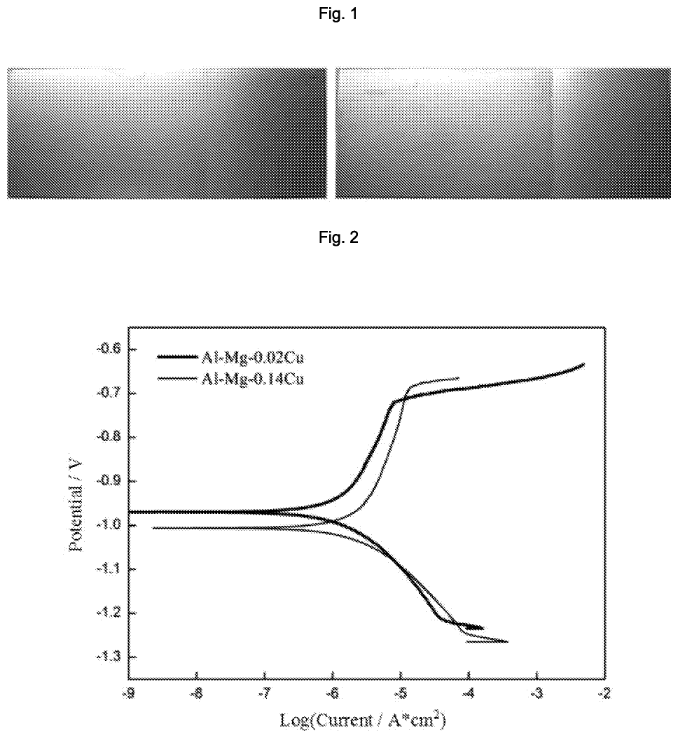

The prepared aluminum alloy finished product sheet was subjected to a water boiling experiment according to the following method: the sample was sized to 100 mm×40 mm, the surface of which was firstly cleaned with acetone or alcohol to remove oil stains, then washed with 5% NaOH solution for 1 min, after washing with water, it was immersed in 30% HNO₃ solution and cleaned for 30 seconds, then washed with pure water before dried at room temperature, the specimen was then heated in a water bath at 90° C. for 15 min, then taken out, cleaned, and oven-dried. The macroscopic morphology after the water boiling experiment is shown in the right image in FIG. 1, where the wider part on the left side of the image is the water boiled part, and it can be seen from the image that the color is changed significantly after the water boiling. The water boiling experiment can preliminarily determine the surface activity of aluminum alloy materials. The more obvious the color change, the higher the surface activity, and the higher the phosphating reactivity.

The prepared aluminum alloy finished product sheet was subjected to polarization curve testing according to the following method: the sample was sized to 20 mm×40 mm, the test surface was ground and polished, then cleaned and dried. The test adopted a three-electrode system, with aluminum alloy specimen as the working electrode, platinum plate as the auxiliary electrode, and saturated calomel electrode as the reference electrode, the test solution was 3.5% of NaCl solution, the potential scanning rate was 1 mV/s, the scanning range was −1.6-0.4 V, and the test results are as shown in FIG. 2.

### Example 2

Al—Mg alloy included by mass percentage of 0.25% of Si, 0.4% of Fe, 0.3% of Mn, 4.5% of Mg, 0.1% of Cr, 0.14% of Cu and a balance of Al. It was smelted according to the above ratio of alloy components, the melt was cast into an ingot by use of a semi-continuous casting equipment after the refining treatment; the ingot was subjected to homogenization treatment after cropping and milling, with the homogenization process being at 430° C. and heat preservation for 5 hours, followed by 520° C. and heat preservation for 5 hours; afterwards, it was hot rolled to a thickness of 6 mm; the hot rolled plate was cold rolled to 4 mm, and subjected to intermediate annealing, which was heated at a rate of 30° C./h to 330° C. and held at that temperature for 4 hours, and air cooled to room temperature after being discharged from the furnace; then, the subsequent cold rolling was carried out to obtain a 1.5 mm-thick cold-rolled plate, afterwards the finished product annealing treatment was carried out and heated at a rate of 30° C./s on the continuous annealing line to 500° C. and held at that temperature for 2 min before water quenching and then cooled at a rate of 20° C./s. Finally, it was straightened on a straightening machine, with a straightening amount of 1%.

### Example 3

Al—Mg alloy included by mass percentage of 0.25% of Si, 0.4% of Fe, 0.45% of Mn, 2.7% of Mg, 0.25% of Cr, 0.43% of Cu and a balance of Al. It was smelted according to the above ratio of alloy components, the melt was cast into an ingot by use of a semi-continuous casting equipment after the refining treatment; the ingot was subjected to homogenization treatment after cropping and milling, with the homogenization process being at 400° C. and heat preservation for 8 hours, followed by 490° C. and heat preservation for 8 hours; afterwards, it was hot rolled to a thickness of 5 mm; the hot rolled plate was cold rolled to 4 mm, and subjected to intermediate annealing, which was heated at a rate of 20° C./h to 300° C. and held at that temperature for 6 hours, and air cooled to room temperature after being discharged from the furnace; then, the subsequent cold rolling was carried out to obtain a 0.8 mm-thick cold-rolled plate, afterwards the finished product annealing treatment was carried out and heated at a rate of 30° C./s on the continuous annealing line to 450° C. and held at that temperature for 2 min before water quenching and then cooled at a rate of 20° C./s. Finally, it was straightened on a straightening machine, with a straightening amount of 1%.

### Example 4

Al—Mg alloy included by mass percentage of 0.25% of Si, 0.4% of Fe, 0.45% of Mn, 2.7% of Mg, 0.25% of Cr, 0.43% of Cu and a balance of Al. It was smelted according to the above ratio of alloy components, the melt was cast into an ingot by use of a semi-continuous casting equipment after the refining treatment; the ingot was subjected to homogenization treatment after cropping and milling, with the homogenization process being at 440° C. and heat preservation for 5 hours, followed by 510° C. and heat preservation for 5 hours; afterwards, it was hot rolled to a thickness of 6 mm; the hot rolled plate was cold rolled to 4 mm, and subjected to intermediate annealing, which was heated at a rate of 30° C./h to 330° C. and held at that temperature for 4 hours, and air cooled to room temperature after being discharged from the furnace; then, the subsequent cold rolling was carried out to obtain a 2.5 mm-thick cold-rolled plate, afterwards the finished product annealing treatment was carried out and heated at a rate of 30° C./s on the continuous annealing line to 500° C. and held at that temperature for 2 min before water quenching and then cooled at a rate of 20° C./s. Finally, it was straightened on a straightening machine, with a straightening amount of 1%.

The prepared aluminum alloy finished product sheet was subjected to metallographic structure testing, the testing method involved preparing metallographic samples along the thickness direction of the sheet, grinding and polishing, corroding same with a Keller reagent for 20-50 seconds, and then observing under a metallographic microscope. The testing results are shown on the right side of FIG. 3.

### Example 5

The difference from example 2 lied in that Al—Mg alloy included by mass percentage of 0.25% of Si, 0.4% of Fe, 0.3% of Mn, 4.5% of Mg, 0.1% of Cr, 0.06% of Cu and a balance of Al.

### Example 6

The difference from example 3 lied in that Al—Mg alloy included by mass percentage of 0.25% of Si, 0.4% of Fe, 0.45% of Mn, 2.7% of Mg, 0.25% of Cr, 0.5% of Cu and a balance of Al.

### Example 7

The difference from example 1 lied in that the homogenization treatment process involves holding at 350° C. for 3 hours, followed by holding at 430° C. for 3 hours.

### Example 8

The difference from example 1 lied in that the homogenization treatment process was at 500° C. and heat preservation for 3 hours, followed by 550° C. and heat preservation for 3 hours.

### Example 9

The difference from example 1 lied in that the homogenization process was at 450° C. and heat preservation for 2 hours, followed by 530° C. and heat preservation for 2 hours.

### Comparative Example 1

Al—Mg alloy included by mass percentage of 0.25% of Si, 0.4% of Fe, 0.3% of Mn, 4.5% of Mg, 0.1% of Cr, 0.02% of Cu and a balance of Al. It was smelted according to the above ratio of alloy components, the melt was cast into an ingot by use of a semi-continuous casting equipment after the refining treatment; the ingot was subjected to homogenization treatment after cropping and milling, with the homogenization process being at 450° C. and heat preservation for 3 hours, followed by 530° C. and heat preservation for 3 hours; afterwards, it was hot rolled to a thickness of 5 mm; the hot rolled plate was cold rolled to 4 mm, and subjected to intermediate annealing, which was heated at a rate of 30° C./h to 350° C. and held at that temperature for 2 hours, and air cooled to room temperature after being discharged from the furnace; then, the subsequent cold rolling was carried out to obtain a 2 mm-thick cold-rolled plate, afterwards the finished product annealing treatment was carried out and heated at a rate of 30° C./s on the continuous annealing line to 530° C. and held at that temperature for 30 seconds before water quenching and then cooled at a rate of 20° C./s. Finally, it was straightened on a straightening machine, with a straightening amount of 1%.

The water boiling experiment was carried out with the same method as example 1, and the macroscopic morphology after the experiment is shown in the left image of FIG. 1, where the left side of the image shows the water boiled part. Moreover, the polarization curve testing was carried out with the same method as example 1, and the testing results are shown in FIG. 2.

### Comparative Example 2

Al—Mg alloy included by mass percentage of 0.25% of Si, 0.4% of Fe, 0.3% of Mn, 4.5% of Mg, 0.1% of Cr, 0.75% of Cu and a balance of Al. It was smelted according to the above ratio of alloy components, the melt was cast into an ingot by use of a semi-continuous casting equipment after the refining treatment; the ingot was subjected to homogenization treatment after cropping and milling, with the homogenization process being at 450° C. and heat preservation for 3 hours, followed by 530° C. and heat preservation for 3 hours; afterwards, it was hot rolled to a thickness of 5 mm; the hot rolled plate was cold rolled to 4 mm, and subjected to intermediate annealing, which was heated at a rate of 30° C./h to 350° C. and held at that temperature for 2 hours, and air cooled to room temperature after being discharged from the furnace; then, the subsequent cold rolling was carried out to obtain a 2 mm-thick cold-rolled plate, afterwards the finished product annealing treatment was carried out and heated at a rate of 30° C./s on the continuous annealing line to 530° C. and held at that temperature for 30 seconds before water quenching and then cooled at a rate of 20° C./s. Finally, it was straightened on a straightening machine, with a straightening amount of 1%.

### Comparative Example 3

Al—Mg alloy included by mass percentage of 0.25% of Si, 0.4% of Fe, 0.3% of Mn, 4.5% of Mg, 0.1% of Cr, 0.43% of Cu and a balance of Al. It was smelted according to the above ratio of alloy components, the melt was cast into an ingot by use of a semi-continuous casting equipment after the refining treatment; the ingot was subjected to homogenization treatment after cropping and milling, with the homogenization process being at 530° C. and heat preservation for 8 hours; afterwards, it was hot rolled to a thickness of 5 mm; the hot rolled plate was cold rolled to 4 mm, and subjected to intermediate annealing, which was heated at a rate of 20° C./h to 300° C. and held at that temperature for 6 hours, and air cooled to room temperature after being discharged from the furnace; then, the subsequent cold rolling was carried out to obtain a 0.8 mm-thick cold-rolled plate, afterwards the finished product annealing treatment was carried out and heated at a rate of 30° C./s on the continuous annealing line to 450° C. and held at that temperature for 2 min before water quenching and then cooled at a rate of 20° C./s. Finally, it was straightened on a straightening machine, with a straightening amount of 1%.

### Comparative Example 4

The difference from comparative example 3 lied in that the temperature of the homogenization process was at 430° C. and heat preservation for 8 hours.

The sheets prepared by the above processes were evaluated for the phosphating properties and intergranular corrosion properties, the specific methods were as follows:

1. Evaluation of Phosphating Properties:

The phosphating process was consisted of 5 procedures, including degreasing and water washing, surface conditioning, phosphating, and water washing.

Degreasing: using a mixed solution of 5% by mass percentage of an alkaline degreaser and 1% by mass percentage of a surfactant for treating 5 min at a degreasing temperature of 50° C.

Water washing: washing with tap water for 3 min at a washing temperature of 25° C.

Surface conditioning: using 0.2% by mass percentage of a titanium polyphosphate surface conditioning agent for treating 3 min at a surface conditioning temperature of 30° C.

Phosphating: using a mixed solution composed of 5% by mass percentage of a main film forming agent, 2.5% by mass percentage of a neutralizer, 0.2% by mass percentage of an accelerator, 0.3% by mass percentage of a manganese additive, 0.3% by mass percentage of a nickel additive, 0.75% by mass percentage of a fluorosilicate and 0.3% by mass percentage of a fluoride ion additive for treating 5 min at a phosphating temperature of 50° C., wherein the free acid point of the mixed solution was 1.8, the total acid point was 30, the fluoride ion concentration was 180 ppm, and the accelerator gas point was 3.

Water washing: washing with tap water for 3 min. The washing temperature was 25° C.

SEM inspection was carried out on the phosphated surface, and coverage of the phosphating film in the selected area was statistically measured, and the phosphating crystal size was measured.

Evaluation criteria: coverage of the phosphating film of 95%, and the phosphating film crystal size of 2-8 μm were qualified.

The Al—Mg series aluminum alloy sheets prepared in example 1 and comparative example 1 were phosphatized according to the above steps, and then subjected to SEM scanning. The scanning photographs are shown in FIG. 3.

2. Evaluation of Intergranular Corrosion Properties:

Specimen processing: 1. The specimen was sized to 50 mm×30 mm×thickness, the surface was polished to smoothness with 2000 #sandpaper; 2. Before the test, the specimen was subjected to the following treatments in sequence: acetone cleaning; cleaning with 5% NaOH solution at 80° C. for 1 min; water washing; cleaning with a 70% HNO₃ solution for 30 seconds; cleaning with deionized water; acetone cleaning; drying at room temperature; and weighing the weight m₀ (±0.1 mg) before corrosion. 3. Immersing the specimen in a 70% HNO₃ solution at (30.0±0.2°) C. for 24 hours±15 min, with a beaker volume of 150 mL and the opening was sealed with a thin film (volume/area ratio>3 mL/cm 2), one specimen was placed in each beaker. 4. The specimen was subjected to the following treatments in sequence after being taken out: cleaning with tap water (or immersing for 30 min), and the residues were removed with a medium hardness toothbrush during the rinsing process; cleaning with distilled water; acetone cleaning plus 10 min of acetone ultrasonic cleaning; drying at room temperature; weighing (±0.1 mg) and recording the weight mi after corrosion.

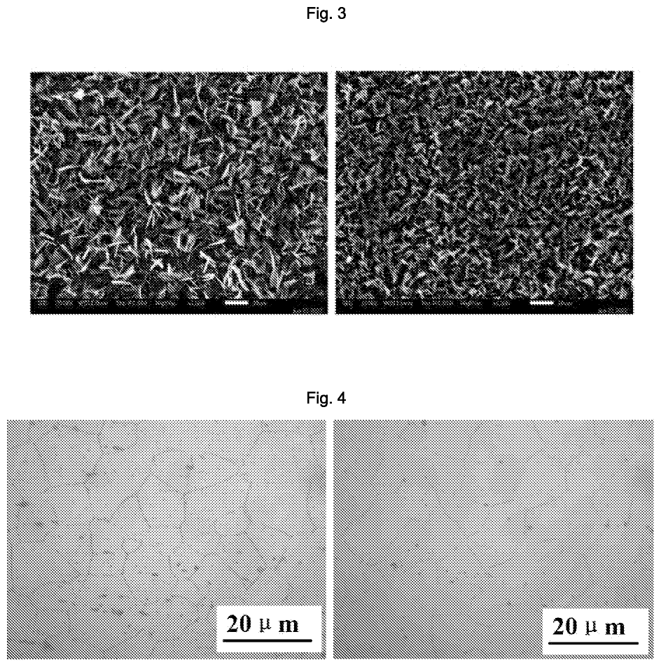

Evaluation criteria: intergranular corrosion was evaluated based on corrosion weight loss, and the quality loss of sheet in original state of less than 3 mg/cm 2 was considered as qualified; and the quality loss of sheet after the sensitization treatment at 195° C. for 45 min of less than 30 mg/cm 2 was considered as qualified. Among them, the metallographic structures of the Al—Mg series aluminum alloy sheets prepared in example 4 and comparative example 3 after the sensitization treatment at 195° C. for 45 min are shown in FIG. 4.

TABLE 1
Testing Results of properties of Aluminum Alloy Sheet

| | Evaluation of phosphating properties | | | Evaluation of intergranular corrosion | | |
|---|---|---|---|---|---|---|
| | Coverage of | Crystal | Judgment | Original | sensitization | Judgment |
| Test | the phosphating | size/ | of | state/ | treatment/ | of |
| example | film/% | μm | qualification | mg/cm² | mg/cm² | qualification |
| Example 1 | 97.5 | 5.3 | Qualified | 1.24 | 11.8 | Qualified |
| Example 2 | 97.3 | 5.0 | Qualified | 1.46 | 10.3 | Qualified |
| Example 3 | 99 | 3.2 | Qualified | 2.45 | 19.6 | Qualified |
| Example 4 | 98.8 | 3.6 | Qualified | 2.33 | 23.5 | Qualified |
| Example 5 | 95.5 | 6.3 | Qualified | 0.85 | 9.8 | Qualified |
| Example 6 | 99.5 | 2.5 | Qualified | 2.68 | 26.9 | Qualified |
| Example 7 | 96.1 | 7.5 | Qualified | 1.98 | 12.3 | Qualified |
| Example 8 | 97.3 | 7.0 | Qualified | 1.42 | 16.2 | Qualified |
| Example 9 | 97.3 | 5.6 | Qualified | 1.32 | 10.8 | Qualified |
| Comparative | 93.6 | 9.5 | Unqualified | 0.76 | 8.3 | Qualified |
| example 1 | | | | | | |
| Comparative | 99.8 | 2.3 | Qualified | 3.43 | 36.7 | Unqualified |
| example 2 | | | | | | |
| Comparative | 99.1 | 3.4 | Qualified | 3.21 | 27.9 | Unqualified |
| example 3 | | | | | | |
| Comparative | 98.6 | 3.5 | Qualified | 3.36 | 28.5 | Unqualified |
| example 4 | | | | | | |

From the above description, it can be seen that through optimizing the content of each component, especially the microelement Cu, as well as the homogenization annealing process in the preparation method of an Al—Mg series aluminum alloy sheet provided in the application, the phosphating reactivity of the material is improved, and the dense and uniform growth of the surface phosphating film is promoted, at the same time it provides good resistance to intergranular corrosion, ensuring that the alloy's intergranular corrosion performance meets the certification requirements of the main engine plants.

The above contents only describe the preferred examples of the disclosure, and are not intended to limit the disclosure. For those skilled in the art, various modifications and changes can be made to the disclosure. Any modifications, equivalent substitutions, improvements, and the like made within the spirit and principle of the disclosure shall be included within the scope of protection of the disclosure.

What is claimed is:

1. A preparation method of an Al—Mg series aluminum alloy sheet, wherein the preparation method comprising:
step S1, melting and casting the alloy raw materials sequentially to obtain an aluminum alloy ingot; wherein the alloy raw materials comprise the following components as calculated by mass percentage: ≤0.4% content of Si; ≤0.4% content of Fe; 0.2%-0.5% content of Mn; 2.2%-6.0% content of Mg; ≤0.3% content of Cr; 0.05%-0.5% content of Cu, and a balance of Al and impurities, with a total amount of impurities being less than 0.15 wt %, and each impurity element content being less than 0.05 wt %;
step S2, subjecting the aluminum alloy ingot to a two-stage homogenization treatment so as to obtain a homogenized aluminum alloy ingot; and
step S3, subjecting the homogenized aluminum alloy ingot to hot rolling, primary cold rolling, intermediate annealing, final cold rolling, and finished product annealing sequentially to obtain the aluminum alloy sheet.

2. The preparation method according to claim 1, wherein the two-stage homogenization treatment comprises a first-stage homogenization treatment and a second-stage homogenization treatment, wherein the temperature of the first-stage homogenization treatment is 380-460° C., and the temperature of the second-stage homogenization treatment is 490-530° C.

3. The preparation method according to claim 2, wherein the heat preservation time of the first-stage homogenization treatment is 2-8 hours, and the heat preservation time of the second-stage homogenization treatment is 2-8 hours.

4. The preparation method according to claim 1, wherein the hot-rolled plate obtained after the hot rolling in step S3 has a thickness of 5.0-8.0 mm;
and/or, the sheet obtained from the primary cold rolling in step S3 has a thickness of 1.6-5.0 mm;
and/or, the sheet obtained from the final cold rolling in step S3 has a thickness of 0.8-3.0 mm.

5. The preparation method according to claim 1, wherein in the step S3, the intermediate annealing comprises: heating the sheet to 300-350° C. at a heating rate of 20-50° C./h and holding at that temperature for more than 2 hours;
and/or, the finished product annealing comprises: heating the sheet to 450-530° C. at a heating rate of greater than 20° C./s and holding at that temperature for 15s-5 min for continuous annealing, and then cooling same at a rate of greater than 10° C./s.

6. The preparation method according to claim 1, wherein the step S3 further comprises straightening the finished product after annealing, with a straightening amount of 0.5-1%.

7. The preparation method according to claim 1, wherein the preparation method further comprises: step S4, subjecting the aluminum alloy sheet to phosphating treatment, wherein the phosphating treatment comprises degreasing, water washing, surface conditioning, phosphating, and final water washing in sequence.

8. The preparation method according to claim 7, wherein the degreasing comprises treating with a mixed solution of 3%-5% by mass percentage of an alkaline degreaser and 0.6%-1% by mass percentage of a surfactant at 45-55° C. for 1-10 min;
and/or, the water washing and final water washing comprise washing with water for 1-5 min at a washing temperature of 20-30° C.;
and/or, the surface conditioning comprises treating with 0.1%-0.2% by mass percentage of a titanium polyphosphate surface conditioning agent for 0.5-5 min at a treating temperature of 20-35° C.;
and/or, the phosphating comprises treating with a mixed solution composed of 4%-5% by mass percentage of a main film forming agent, 2%-3% by mass percentage of a neutralizer, 0.1%-0.2% by mass percentage of an accelerator, 0.1%-0.5% by mass percentage of a manganese additive, 0.1%-0.5% by mass percentage of a nickel additive, 0.5%-1% by mass percentage of a fluorosilicate and 0.1%-0.5% by mass percentage of a fluoride ion additive for 3-5 min at a treating temperature of 40-60° C., wherein the free acid point of the mixed solution is 1.5-2.0, the total acid point is 25-30, the fluoride ion concentration is 150-200 ppm, and the accelerator gas point is 2-4.

9. An Al—Mg series aluminum alloy sheet, wherein the Al—Mg series aluminum alloy sheet is prepared by the preparation method according to claim 1.

10. Use of the Al—Mg series aluminum alloy sheet according to claim 9 in the body structural member and/or cover panel inner plate.
